(19) United States
(12) Patent Application Publication
(10) Pub. No.: US 2011/0048629 A1
(43) Pub. Date: Mar. 3, 2011

(54) VACUUM DRUM FOR LABELLING MACHINES

(76) Inventors: James Frederick Robertson Carmichael, Kendal (GB); Marco Domeniconi, Rimini (IT)

(21) Appl. No.: 12/863,315

(22) PCT Filed: Feb. 26, 2008
(86) PCT No.: PCT/EP2008/052284

§ 371 Date: Jul. 16, 2010

(51) Int. Cl. B65C 9/18; B65C 9/22

(52) U.S. Cl. 156/264; 156/510

(57) ABSTRACT

The present invention relates to an improved vacuum drum for handling labels in labelling machines to be used for labelling containers such as bottles. In particular, the present invention relates to a vacuum drum system (1) for labelling machines, comprising a vacuum drum (2) rotatably supported on a non-rotating base (12), a feeding and cutting group (4) for the labels and a gluing group (5) having a gluing drum for the label, characterised in that it comprises a suction system (3) for withdrawing hot glue filaments originating from the glued label assisted by air jets emitted from the drum surface, the said suction system (3) being positioned adjacent to and downstream the gluing drum of the said gluing group (5), along the direction of rotation of the said vacuum drum (2). A method of operating the said system is also claimed.

The present invention relates to an improved vacuum drum for handling labels in labelling machines to be used for labelling containers such as bottles.

Labelling machines for gluing labels and transferring them onto the surface of containers are known and widespread used. In these machines the containers are carried by a carrousel and come into contact with a labelling unit. The labelling unit comprises a so called “vacuum drum” that receives a label strip from a roll feeding group, cuts the label at the appropriate length, glue the label by means of appropriate means, such as a gluing drum, spray and injector systems or the like, and finally transfer the label to the container. During these handling operations, the label is retained on the vacuum drum by means of vacuum applied on the label. To this purpose, the surface of the vacuum drum comprises a plurality of orifices that are in communication with a vacuum source.

The known machines have a serious drawback. As the glue is viscous, glue filaments are formed between the glued surface of the label and the gluing drum. These filaments are then dragged by the label during the rotation of the vacuum drum, so that the glue can soil the whole unit, making the cleaning operations difficult and lengthy.

The problem faced by the present invention is to provide a system that overcomes the above drawback.

This problem is solved by a vacuum drum system for a combined blow off-suction of the glue filament such as outlined in the annexed claims, whose wording is integral part of the present description.

Further features and advantages of the present invention will be better understood from the description of a preferred embodiment, which is given below by way of a non-limiting illustration, with reference to the following figures:

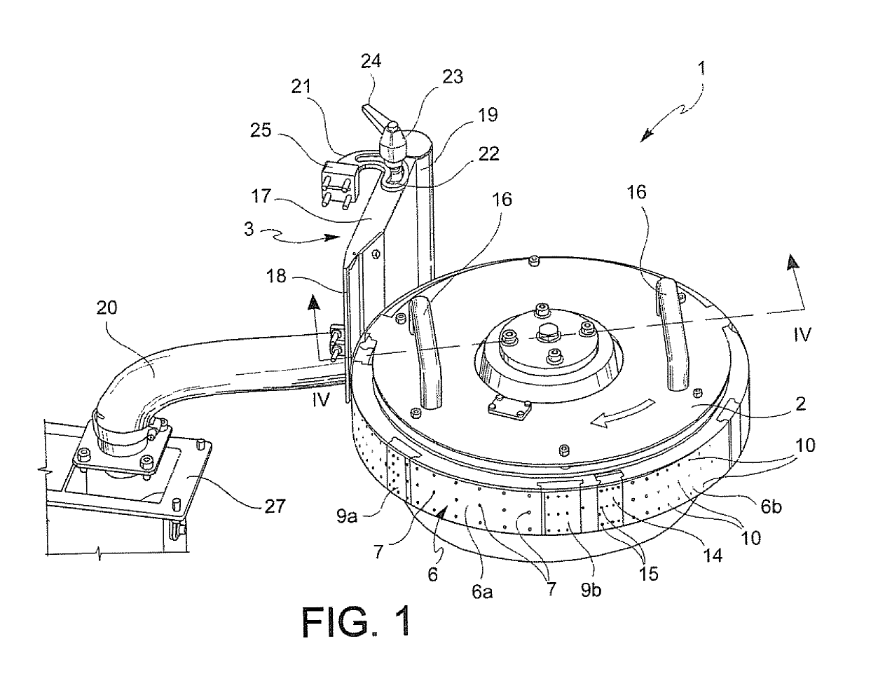

FIG. 1 is a perspective view of the vacuum drum system of the invention;

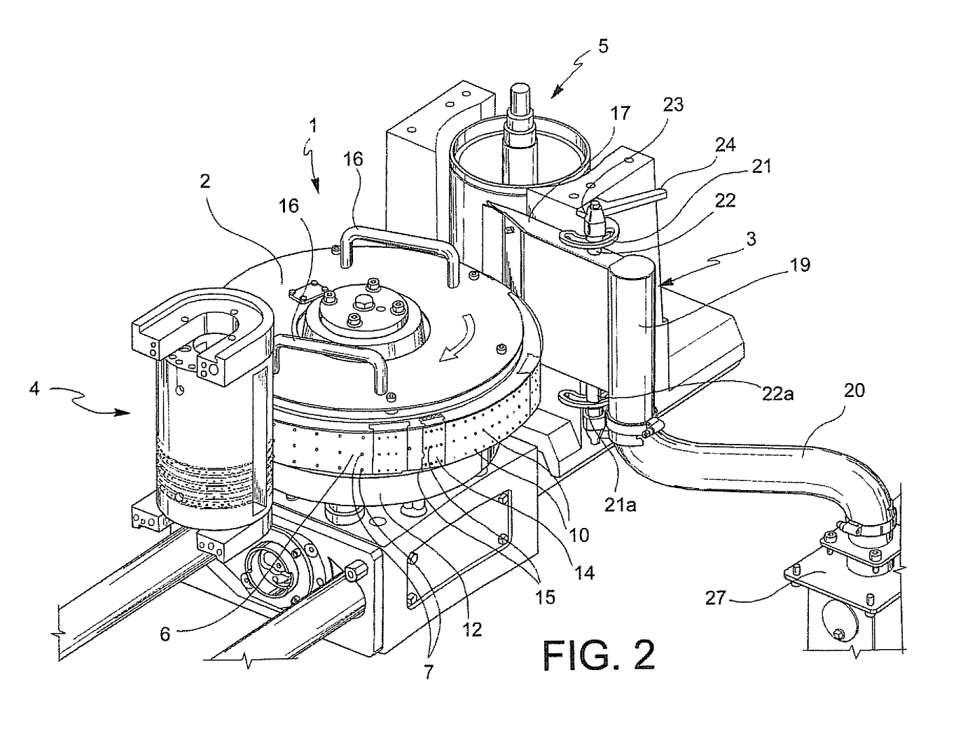

FIG. 2 is a perspective view of a labelling unit comprising the system of FIG. 1;

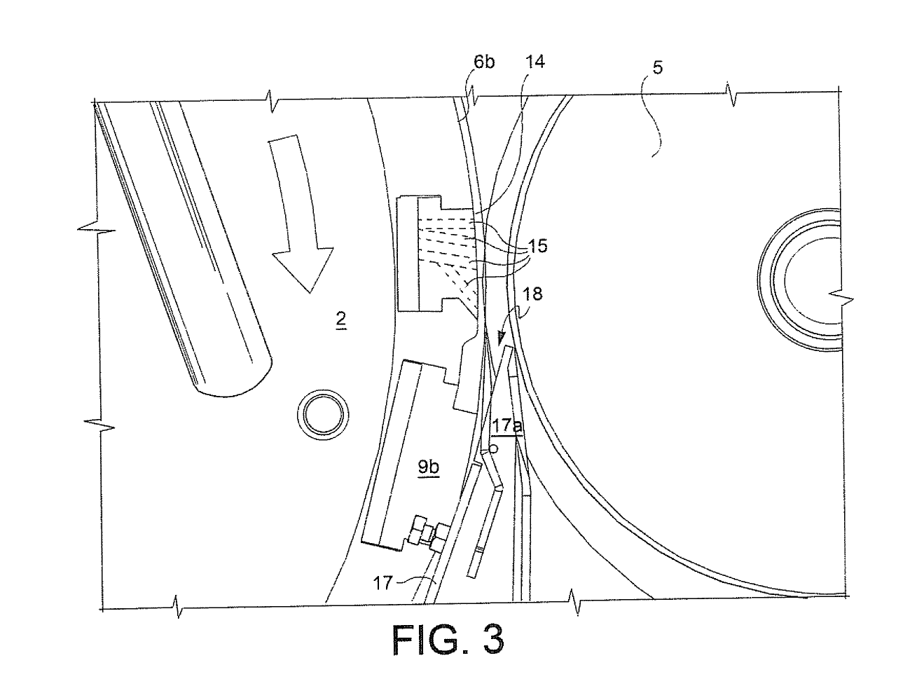

FIG. 3 is a top plan view of a particular of the system of FIG. 1;

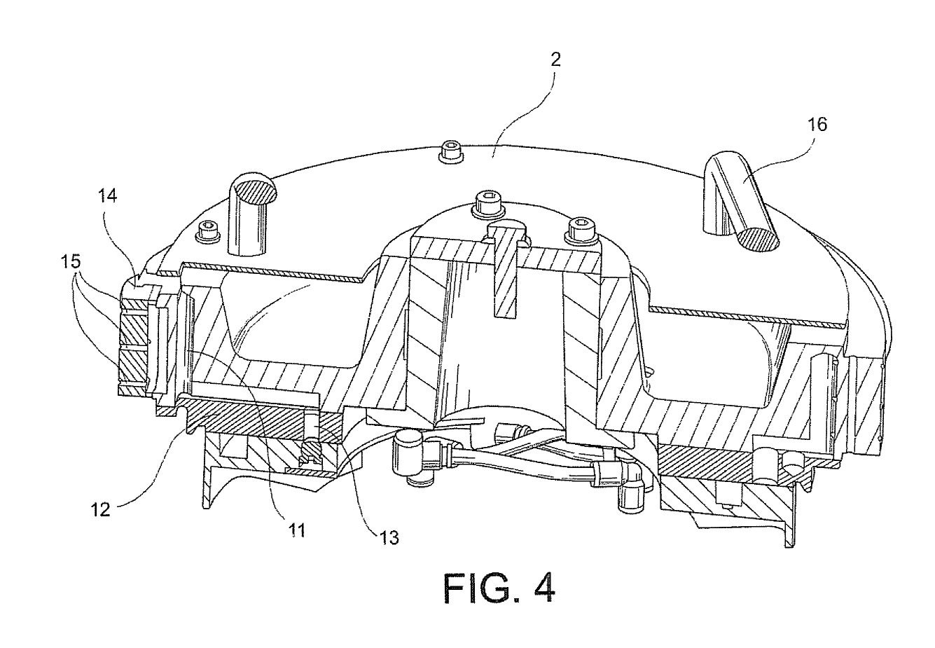

FIG. 4 is a cross section perspective view along the line IV-IV of FIG. 1;

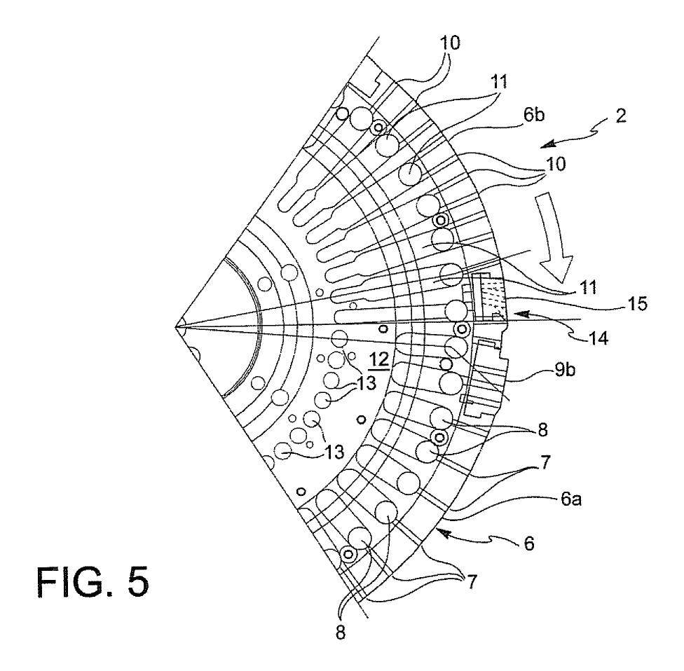

FIG. 5 is a top sectional view of the vacuum drum of the invention;

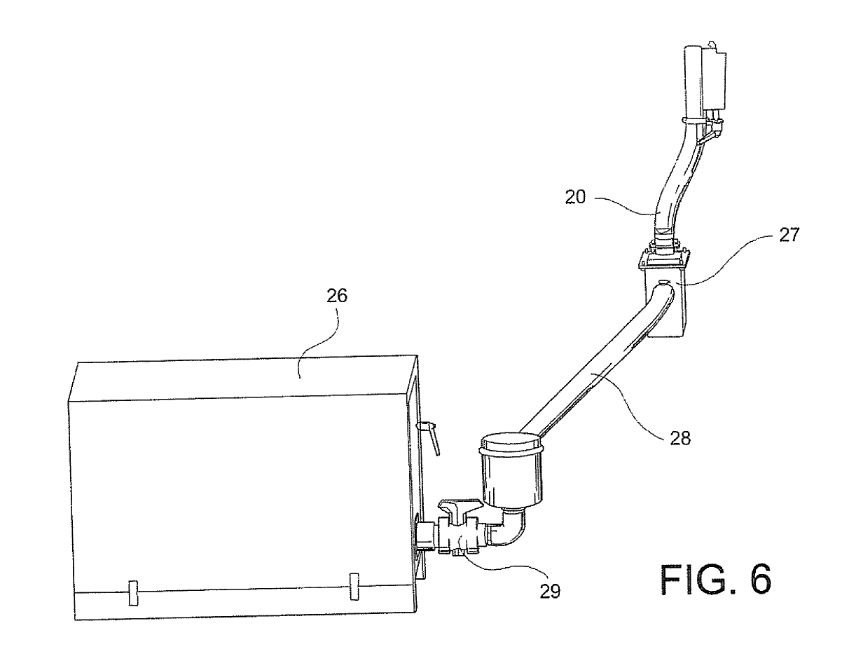

FIG. 6 is a simplified perspective view of the suction system for the glue filaments according to the invention.

With reference to the figures, the vacuum drum system of the invention, wholly indicated with the numeral 1, comprises a vacuum drum 2 and a suction system 3 for the glue filaments. As shown in FIG. 2, the vacuum drum system 1 is positioned in a labelling unit that also comprises a feeding and cutting group 4 as well as a gluing group 5 in juxtaposed relationship. The feeding and cutting group 4 provides for feeding a label strip from a label roll (not shown) and cutting the label to the desired length. The gluing group 5 comprises gluing means such as a gluing drum for gluing the label that is previously fed and retained by the vacuum drum. Spray and injector systems can also be used as gluing means. Downstream from the gluing group 5, the label arrives to the label transferring station (not shown) that provides for transferring the label to the container that is synchronously driven by the main carrousel. Feeding and cutting group 4, gluing group 5, as well as label transferring station are conventional and are not subject of the present invention, so that they will not be described in more details.

The vacuum drum 2 is independently driven by a motor, such as a brushless motor or the like, placed below the drum or is driven by the carrousel motor through suitable gears.

The top surface of the vacuum drum 2 comprises handle means 16 to facilitate its removal or mounting during the normal cleaning operations or any other technical intervention.

The vacuum drum 2 comprises peripherally a lateral surface 6 to engage with the label. The lateral surface comprises at least one first section 6a having a plurality of through holes 7 in communication with internal passages 8 (FIG. 5). These passages 8 can be connected to a vacuum source by means of suitable orifices or manifolds present on the non-rotating base 12 on which the vacuum drum is supported and rotated. In other words, when the rotating vacuum drum 2 reaches a position where the said passages 8 are in alignment with said orifices or manifolds, vacuum is applied on the surface of the said first section 6a.

In a preferred embodiment, three first sections 6a are present on the vacuum drum 2, as shown in the figures. Nevertheless, a different number of first sections 6a can be provided, depending on the capacity of the machine and mainly on the length of the labels, which means that more or less than three first sections 6a can be provided.

In the embodiment shown in the figures, two pads 9a, 9b are disposed at the two extremities of the at least one first section 6a of the lateral surface 6. This is normally called the “transfer zone”, wherein the label slides so that glue contamination is a problem. These pads 9a, 9b are slightly protruding from the lateral surface 6 and have the function to engage with the leading and the trailing ends of the label, respectively. To this purpose, the pads 9a, 9b present a plurality of through holes in communication with the said passages 8 for the vacuum.

While the lateral surface 6 of the vacuum drum is generally made of nickel plated aluminium (stainless steel can also be used in special applications), the pads 9a, 9b are preferably made of plastics material and are removable in order to be substituted when necessary.

It should be understood that in different embodiments, the pads 9a, 9b can be simply replaced by a prolongation of the said first section 6a of the lateral surface 6 and thus can be integral with such a surface.

The lateral surface 6 of the vacuum drum 2 also comprises at least one second section 6b adjacent to said at least one first section 6a in an upstream relationship with this latter with respect to the direction of rotation of the vacuum drum 2 (see arrow in FIG. 1). One second section 6b for each first section 6a is provided, so that according to the preferred embodiment, three second sections 6b are present.

The number of the said first and second sections 6a, 6b will depend on the length of the labels. The longer are the labels the less sections 6a, 6b are provided.

The said at least one second section 6b (that is usually called “inter pad” zone) is provided with a plurality of through holes 10. The said through holes 10 are in communication with elongated passages 11 that are positioned internally to the vacuum drum 2. The elongated passages 11 extend to a series of orifices 13 located on the non-rotating base 12, to which they can be put into communication as the rotating vacuum drum 2 reaches a position where the elongated passages 11 are in alignment with said orifices 13. The orifices 13 are on their turn in communication with means (not shown), such fan means or a compressed air source or the like, in order to provide a stream of air under pressure from the said through holes 10 when the said elongated passages 11 are in alignment with said orifices 13.

The elongated passages 11 are also in flow communication with a second series of orifices to apply vacuum, which are present on the base 12, along a more external circumference and offset with respect to the said orifices 13. This is because the through holes 10 can serve different functions depending on the position of the vacuum drum 2 relative to the base 12, as will be explained herein after.

A sub-section 14 of the second section 6b is provided. According to the embodiment shown in the figures, this sub-section 14 is made up of a separate element, but it should be understood that it is equally foreseen that the sub-section 14 is integral with the second section 6b.

The sub-section 14 is close to the pad 9b that receives the trailing end of the label and is provided with a plurality of through holes 15.

As shown in FIGS. 3 and 5, the said through holes 15 are all or in part slanting relative to the radius of the drum, so that they are facing toward the direction of rotation of the vacuum drum 2. More in detail, according to a preferred embodiment of the invention there are four vertical series of through holes 15: the first vertical series, starting from the pad 9b, originate internally as a branch of the second series and is very slanting. The second and the third series of through holes 15 are less slanting, while the fourth series is substantially radial.

The said through holes 15 are also in communication, by means of respective elongated passages 11, with the said orifices 13 for blowing air under pressure.

The suction system 3 will be now described.

The suction system 3 comprises a suction head 17. In the shown example, the suction head 17 is made up of a substantially flat, hollow body tapered at one end, wherein it terminates with a slot or any other inlet aperture 18. A substantially flat passage 17a is thus defined inside the suction head 17.

At the opposite end, the suction head 17 is connected to a manifold means 19 that is on its turn in flow communication with a suction pipe 20. In the exemplary figure, the manifold means 19 is substantially cylindrical and closed at its top end, while the suction pipe 20 is connected at the bottom end of the manifold means 19. However, it should be understood that any other shape or arrangement of the different parts of the suction system can be provided as well without departing from the scope of the present invention.

The suction pipe 20 is made up of a material that is resistant to high temperature, as the sucked glue is very hot.

The suction head 17 is positioned vertically along a direction that is substantially tangential to the vacuum drum 2, with the tapered side looking at the drum so that the inlet aperture 18 is at a short distance from the vacuum drum 2 surface and faces against the direction of rotation of the drum.

In order to be adjustable, the suction head 17 is hinged to guiding means 21 that preferably comprise an arcuate slot wherein a pin 22 can run. The pin 22 is threaded and is in engagement with a bolt 23 that presses against the guiding means 21. Preferably, the bolt 23 is a self-locking bolt. By loosening the bolt 23, moving the pin 22 in the guiding means 21 and tightening the bolt 23 again, it is possible to adjust the position of the suction head 17 relative to the vacuum drum 2. Handle means 24 can be provided to the bolt 23 to facilitate its operation.

The guiding means 21 can be coupled, through suitable fixing means 25 such as a screwed plaque, to the gluing group 5. Analogously, guiding means 21a and a pin 22a can be provided at the bottom end of the suction head 17.

The suction pipe 20 is connected to suction means (FIG. 6) through collecting means 27, such as a collecting box, for the sucked glue. The collecting means 27 are linked by a connecting pipe 28 to the said suction means 26, the said connecting pipe 28 being intercepted by valve means 29 to adjust the vacuum. The valve means 29 can be omitted once the set up of the system is completed or can be replaced by different air flow control means, apt to tune the air flow that is withdrawn by the suction head 17.

A filter (not shown) is preferably interposed up stream the valve means 29, to intercepts glue residues that could possibly pass the said collecting means 27 and contaminate the valve means.

The said collecting means 27 are removable, so that they can be cleaned from time to time.

The operation of the inventive vacuum drum system 1 will now be described.

The vacuum drum 2 works conventionally by rotating in the direction indicated by an arrow in the drawings, so that it first receives the label strip and cuts it to the desired label length at the feeding and cutting group 4 and then retains the label by vacuum on its lateral surface 6. While still rotating the vacuum drum 2, the retained label passes through the gluing group 5. At this stage, glue filaments are normally formed between the label and the gluing drum. Just downward the gluing group 5 there is positioned the suction head 17, so that, when the sub-section 14 of the second section 6b of the vacuum drum lateral surface 6 reaches a position wherein it is in alignment with the inlet aperture 18, at the same time the through holes 15 are put into communication with the orifices 13 connected to fan means or compressed air source through the said elongated passages 11, which are in alignment with said orifices 13. A flow of air under pressure thus exits the through holes 10, 15, so that the glue filament is blown away before contact with the surface of the first section 6a. Concomitantly, the suction head 17—that at this point is aligned with the sub-section 14 as said above—withdraws the glue filaments and send them to the collecting means 27. It should be noted that, when the vacuum drum 2 is in a different rotational position than the one just described, the elongated passages 11 are put into communication with the more external series of orifices to which vacuum is applied, so that in the other positions of the vacuum drum 2 the through holes 10, 15 act to apply vacuum.

The labelling operation is completed by transferring the label to the container at the station downstream the suction system 3. In such a way, the drawback of contaminating the machine surfaces with the glue filaments is completely avoided.

Thus, the invention also encompasses a method for removing glue filaments from a label during the labelling operation of containers in a labelling machine, comprising the steps of:

providing a vacuum drum system 1 according to the present invention and;

removing the glue filament from the label by a combined blow off of the glue filament from the vacuum drum 2 lateral surface 6 and suction of the said glue filament by a suction system 3, the said combined blow off-suction action creating a substantially straight air flow from the lateral surface 6 of the vacuum drum 2 to the internal passage 17a of the suction head 17 of the said suction system 3.

The advantages of the vacuum drum system 1 according to the invention are thus apparent.

The cleaning operation of the machine is greatly improved.

Furthermore, the suction system 3 and the collecting means 27 are easily removable in order to clean them properly.

The suction head 17 is adjustable relative to the vacuum drum 2, so that the better conditions for use are found depending on the different applications.

It will be appreciated that only a particular embodiment of the present invention has been described herein, to which those skilled in the art will be able to make any and all modifications necessary for its adjustment to specific applications, without however departing from the scope of protection of the present invention as defined in the annexed claims.

1. Vacuum drum system (1) for labelling machines, comprising a vacuum drum (2) rotatably supported on a non-rotating base (12), a feeding and cutting group (4) for the labels and a gluing group (5) having gluing means for the label, characterised in that it comprises a suction system (3) for withdrawing hot glue filaments originating from the glued label, the said suction system (3) being positioned adjacent to and downstream the gluing means of the said gluing group (5), along the direction of rotation of the said vacuum drum (2).

2. Vacuum drum system (1) according to claim 1, wherein the said vacuum drum (2) has a lateral surface (6) on which at least one first section (6a) and at least one second section (6b) are defined, the said at least one second section (6b) comprising a plurality of through holes (10, 15) in communication with elongated passages (11) in the rotating vacuum drum (2), the said elongated passages (11) extending to orifices (13) situated on the non-rotating base (12) on which the said vacuum drum (2) is rotatably supported, said orifices (13) being connected with means to blow air under pressure from said through holes (10, 15) when the said elongated passages (11) are in alignment with said orifices (13).

3. Vacuum drum system (1) according to claim 1, wherein the said at least one second section (6b) of the lateral surface (6) of the vacuum drum (2) comprises a sub-section (14) provided with a plurality of through holes (15) that are all or in part slanting relative to the radius of the vacuum drum (2), so that they are facing toward the direction of rotation of the vacuum drum (2).

4. Vacuum drum system (1) according to claim 3, wherein the said sub-section (14) of the said at least one second section (6b) is adjacent to the said at least one first section (6a) and the said plurality of through holes (15) is arranged in four vertical series of through holes (15), the first vertical series, starting from the end adjacent to the said at least one first section (6a), branching from the second series and being slanting; the second and the third series of through holes (15) being less slanting of the said first series and the fourth series being substantially radial.

5. Vacuum drum system (1) according to claim 3, wherein the said sub-section (14) is integral with the said at least second section (6b) of the lateral surface (6) of the vacuum drum (2).

6. Vacuum drum system (1) according to claim 2, wherein the said at least one first section (6a) is provided with a plurality of through holes (7) in communication with internal passages (8) that can be connected to a vacuum source by means of suitable orifices or manifolds present on the non-rotating base (12) on which the vacuum drum is rotatably supported, when the rotating vacuum drum (2) reaches a position where the said passages (8) are in alignment with said orifices or manifolds.

7. Vacuum drum system (1) according to claim 6, wherein two pads (9a, 9b), provided with a plurality of through holes (7) in communication with the said passages (8) for the vacuum, are disposed at the two extremities of the at least one first section (6a) of the lateral surface (6), the said pads (9a, 9b) being slightly protruding from the lateral surface (6) and having the function to engage with the leading and the trailing ends of the label, respectively.

8. Vacuum drum system (1) according to claim 7, wherein the said sub-section (14) of the at least one second section (6b) of the lateral surface (6) of the vacuum drum (2) is adjacent to the said pad (9b) for the trailing end of the label.

9. Vacuum drum system (1) according to claim 2, wherein the said elongated passages (11) are also in flow communication with a second series of orifices to apply vacuum, that are present on the said base (12), along a more external circumference and offset with respect to the said orifices (13).

10. Vacuum drum system (1) according to claim 1, wherein the said suction system (3) comprises a suction head (17) terminating with an inlet aperture (18), a passage (17a) being defined inside the suction head (17).

11. Vacuum drum system (1) according to claim 10, wherein the said suction head (17) is connected to a manifold means (19), which is on its turn in flow communication with a suction pipe (20).

12. Vacuum drum system (1) according to claim 10, wherein the suction head (17) is positioned vertically along a direction that is substantially tangential to the vacuum drum (2), the said inlet aperture (18) being positioned at a short distance from the vacuum drum (2) surface and facing against the direction of rotation of the vacuum drum (2), so that, when the vacuum drum (2) is in a rotational position where the orifices (13) are aligned with the said elongated passages (11), the through holes (15) of the said sub-section (14) of the at least one second section (6b) of the lateral surface (6) and the said inlet aperture (18) are substantially aligned.

13. Vacuum drum system (1) according to claim 10, wherein the suction head (17) is hinged to guiding means (21) shaped in such a way to allow adjustment of the position of the suction head (17) relative to the vacuum drum (2).

14. Vacuum drum system (1) according to claim 13, wherein the said guiding means (21) comprise an arcuate slot wherein a pin (22) can run, the pin (22) being threaded and being in engagement with a bolt (23) that presses against the guiding means (21) to lock or unlock the said suction head (17).

15. Vacuum drum system (1) according to claim 14, wherein the bolt (23) is a self-locking bolt and comprises handle means (24).

16. Vacuum drum system (1) according to claim 13, wherein further guiding means (21a) and a pin (22a) are provided at the bottom end of the suction head (17), the said guiding means (21, 21a) being coupled, through fixing means (25), to the gluing group (5).

17. Vacuum drum system (1) according to claim 11, wherein the said suction pipe (20) is connected to suction means (26) through collecting means (27) for the sucked glue, the said collecting means (27) being linked by a connecting pipe (28) to the said suction means (26).

18. Vacuum drum system (1) according to claim 17, wherein the said connecting pipe (28) is intercepted by valve means (29) to adjust the vacuum.

19. Vacuum drum system (1) according to claim 18, wherein a filter is provided upstream the said valve means (29).

20. Vacuum drum system (1) according to claim 17, wherein the said collecting means (27) are removable.

21. Method for removing glue filaments from a label during the labelling operation of containers in a labelling machine, comprising the steps of:
Providing a vacuum drum system (1) according claim 1;
Removing the glue filament from the label by a combined blow away of the glue filament from the vacuum drum (2) lateral surface (6) and suction of the said glue filament by a suction system (3), the said combined blow away-suction action creating a substantially straight air flow from the lateral surface (6) of the vacuum drum (2) to the internal passage (17a) of the suction head (17) of the said suction system (3).
